(19) United States
(12) Patent Application Publication
(10) Pub. No.: US 2022/0386178 A1
(43) Pub. Date: Dec. 1, 2022

(54) METHOD AND APPARATUS FOR CONFIGURING WIRELESS RELAY COMMUNICATION

(71) Applicant: ELECTRONICS AND TELECOMMUNICATIONS RESEARCH INSTITUTE, Daejeon (KR)

(72) Inventors: Man Ho PARK, Daejeon (KR); Hee Sang CHUNG, Daejeon (KR)

(73) Assignee: ELECTRONICS AND TELECOMMUNICATIONS RESEARCH INSTITUTE, Daejeon (KR)

(21) Appl. No.: 17/741,618

(22) Filed: May 11, 2022

(30) Foreign Application Priority Data
May 28, 2021 (KR) 10-2021-0069521

(51) Int. Cl. H04W 28/18

(52) U.S. Cl. CPC H04W 28/18; H04W 88/04

(57) ABSTRACT

An operation method of a relay terminal in a communication system may comprise: calculating a first available resource amount of a communication service through a base station; calculating a required resource amount for the relay terminal; generating a relay terminal identifier reflecting the first available resource amount and the required resource amount, and providing the relay terminal identifier to a remote terminal; and providing a relay service to the remote terminal when a request for the relay service is received from the remote terminal.

### CROSS-REFERENCE TO RELATED APPLICATIONS

This application claims priority to Korean Patent Application No. 10-2021-0069521 filed on May 28, 2021, with the Korean Intellectual Property Office (KIPO), the entire contents of which are hereby incorporated by reference.

### BACKGROUND

### 1. Technical Field

The present disclosure relates to a technique for configuration of wireless relay communication, and more particularly, to a technique for configuration of wireless relay communication, which enables relay terminal selection and relay path configuration for a relay service.

### 2. Related Art

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered.

In such a 5G communication system, a communication interruption may be caused when an obstacle is located between a base station and a vehicle in providing a communication service to a terminal mounted on the vehicle using a millimeter wave (mmWave) band. Accordingly, the 5G communication system can provide a reliable communication service through a relay service utilizing an adjacent relay terminal. In such a relay service, a change in connection quality may be severe due to factors such as a change in a wireless channel-related environment within a service coverage, mobility of the terminal, and a communication environmental change caused by surrounding vehicles. Therefore, the 5G communication system may frequently apply and adjust factors related to the quality and state of the relay service in order to properly respond to such the environment where the communication service is changed. However, if the 5G communication system frequently performs the relay service processing as described above, it may cause an extreme system load on a network and may degrade the overall communication service quality. Accordingly, the 5G communication system may require a method for reliably controlling and processing the relay service in response to dynamic environmental changes.

### SUMMARY

In order to solve the above-identified problems, exemplary embodiments of the present disclosure are directed to providing a method and an apparatus for configuring wireless relay communication, which can provide a relay service based on direct communication between terminals by providing a procedure for selecting a relay terminal to configure an optimal relay path.

According to a first exemplary embodiment of the present disclosure for achieving the above-described objective, an operation method of a relay terminal in a communication system may comprise: calculating a first available resource amount of a communication service through a base station; calculating a required resource amount for the relay terminal; generating a relay terminal identifier reflecting the first available resource amount and the required resource amount, and providing the relay terminal identifier to a remote terminal; and providing a relay service to the remote terminal when a request for the relay service is received from the remote terminal.

The operation method may further comprise: determining whether an update condition for the relay terminal identifier occurs; and when the update condition occurs, updating the relay terminal identifier according to the update condition.

The update condition may be at least one of a case in which a change in the first available resource amount is equal to or greater than a first threshold and a case in which a change in the required resource amount is equal to or greater than a second threshold.

The providing of the relay service to the remote terminal may comprise: receiving, from the remote terminal, the request for the relay service including a remote terminal identifier reflecting an expected resource amount for a network relay service; calculating the expected resource amount for the network relay service from the remote terminal identifier; calculating a second available resource amount by subtracting the required resource amount from the first available resource amount; and providing the relay service when the first available resource amount is greater than the expected resource amount for the network relay service.

The relay terminal identifier may include a relay capacity field and a ratio code field, the relay capacity field may indicate the first available resource amount, and the ratio code field may indicate a ratio of the required resource amount to the first available resource amount.

According to a second exemplary embodiment of the present disclosure for achieving the above-described objective, an operation method of a remote terminal in a communication system may comprise: calculating a first expected resource amount for an entire relay service; calculating a second expected resource amount for a network relay service; generating a remote terminal identifier reflecting the first expected resource amount and the second expected resource amount; requesting the network relay service by transmitting the remote terminal identifier to candidate relay terminals; and using the network relay service by selecting a relay terminal from among candidate relay terminals responding to the request for the network relay service.

The using of the network relay service may comprise: receiving, from each of the candidate relay terminals, a response to the request for the network relay service including a relay terminal identifier reflecting a first available resource amount and a required resource amount of each of the candidate relay terminals; calculating a result value obtained by subtracting the required resource amount from the first available resource amount for each of the relay terminal identifiers; and using the network relay service by selecting a candidate relay terminal having a largest result value among the result values as a relay terminal.

The remote terminal identifier may include a relay capacity field and a ratio code field, the relay capacity field may indicate the first expected resource amount, and the ratio code field may indicate a ratio of the second expected resource amount to the first expected resource amount.

The operation method may further comprise: determining whether an update condition for the remote terminal identifier occurs; and when the update condition occurs, updating the remote terminal identifier according to the update condition.

The update condition may be at least one of a case in which a change in the first expected resource amount is equal to or greater than a first threshold and a case in which a change in the second expected resource amount is equal to or greater than a second threshold.

The operation method may further comprise: determining whether a reason for termination of use of the network relay service occurs; when the reason for termination of use of the network relay service occurs, requesting termination of the network relay service from the relay terminal; and terminating use of the network relay service.

According to a third exemplary embodiment of the present disclosure for achieving the above-described objective, a relay terminal may comprise: a processor; a memory electronically communicating with the processor; and instructions stored in the memory, wherein when executed by the processor, the instructions cause the relay terminal to: calculate a first available resource amount of a communication service through a base station; calculate a required resource amount for the relay terminal; generate a relay terminal identifier reflecting the first available resource amount and the required resource amount, and provide the relay terminal identifier to a remote terminal; and provide a relay service to the remote terminal when a request for the relay service is received from the remote terminal.

In the providing of the relay service to the remote terminal, the instructions may cause the relay terminal to: receive, from the remote terminal, the request for the relay service including a remote terminal identifier reflecting an expected resource amount for a network relay service; calculate the expected resource amount for the network relay service from the remote terminal identifier; calculate a second available resource amount by subtracting the required resource amount from the first available resource amount; and provide the relay service when the first available resource amount is greater than the expected resource amount for the network relay service.

The relay terminal identifier may include a relay capacity field and a ratio code field, the relay capacity field may indicate the first available resource amount, and the ratio code field may indicate a ratio of the required resource amount to the first available resource amount.

According to the present disclosure, in providing a relay service based on direct communication between terminals using millimeter waves, a remote terminal can efficiently perform a procedure of selecting a relay terminal for configuring an optimal relay path. In addition, according to the present disclosure, as a remote terminal selects an optimal relay terminal for configuring a relay path, connectivity of the relay service can be increased. In addition, according to the present disclosure, deterioration of a service quality due to delay in processing of the relay service can be prevented. In addition, according to the present disclosure, the overall system efficiency as well as the communication service quality for the remote terminal can be increased by effectively providing the relay service.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a first exemplary embodiment of a 5G NR technology-based relay system.

FIG. 4 is a conceptual diagram illustrating a second exemplary embodiment of a 5G NR technology-based relay system.

FIG. 5 is a structural diagram illustrating a first exemplary embodiment of an SL-SCH subheader.

FIG. 6 is a conceptual diagram illustrating a first exemplary embodiment of a wireless relay communication configuration system.

FIG. 7 is a flowchart illustrating a first exemplary embodiment of a relay information processing method of a relay terminal in a wireless relay communication configuration system.

FIG. 8 is a flowchart illustrating a first exemplary embodiment of a relay information processing method of a remote terminal in a wireless relay communication configuration system.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

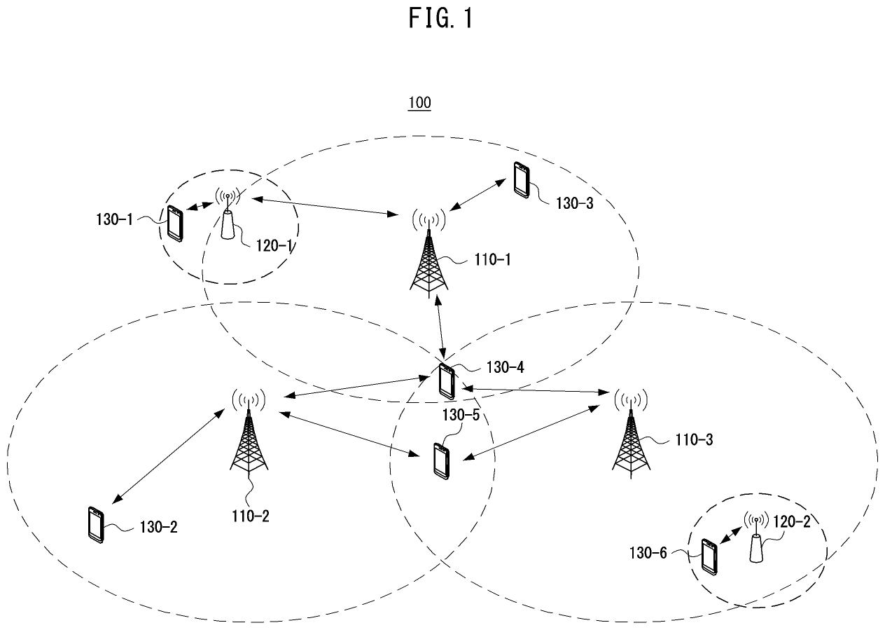

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single-carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have the following structure.

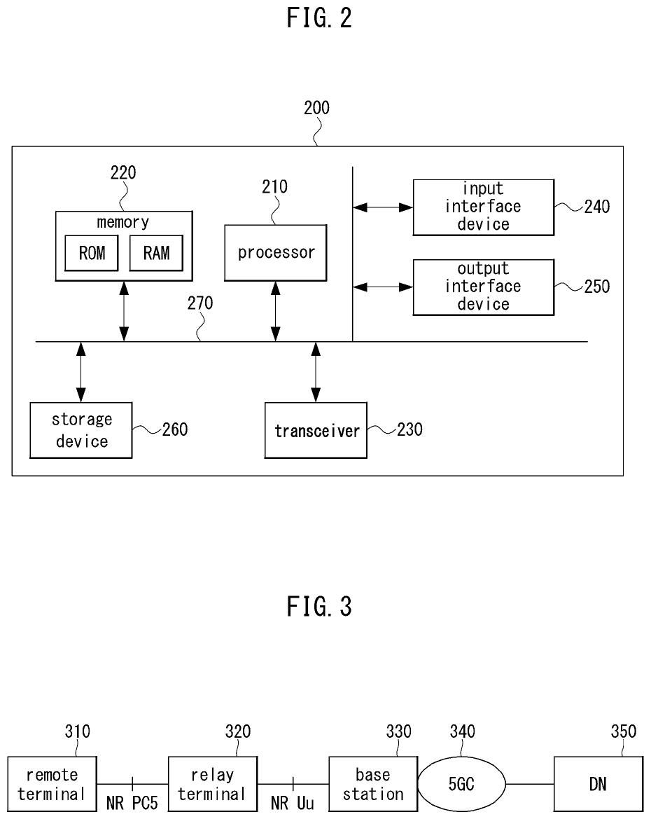

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), relay node, or the like. Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), etc.) defined in the 3rd generation partnership project (3GPP) specification. Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner. Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, as compared to the existing communication schemes, one of the major distinguishing features of the 5G NR technology may be providing a wireless access technology through a high-frequency band of several GHz to several tens of GHz. In such a case, in the 5G NR communication system, connection interference and high transmission loss may occur due to obstacles existing on a propagation path according to the characteristics of the high-frequency band. In addition, in the 5G NR communication system, an instantaneous interruption phenomenon may occur due to a sudden change in the wireless quality environment.

The 5G NR communication system may provide a communication service by applying beamforming to overcome a high path loss caused by a communication service through a very high-frequency band. Here, beamforming may be a technique for generating a dense directional radio beam to radiate or receive a signal in a desired specific direction by using multiple antennas or an array antenna to have radio wave directivity. Such beamforming is one of the main features of multi-antenna technologies. It is characterized by a spatial filtering function for increasing directivity in a desired specific direction and a spatial multiplexing function for combining and transmitting several signals together on a spatial channel.

Such the 5G communication system may cause communication interruption if an obstacle is located between a base station and a vehicle in providing a communication service to a terminal mounted on the vehicle using a millimeter-wave (mmWave) band. Accordingly, the 5G communication system may provide a reliable communication service through a relay service utilizing an adjacent relay terminal. As a related technology, there may be a relay technology using a sidelink. Here, the relay technology using a sidelink may be standardized as a technology for supporting a vehicle-to-everything communication (V2X) service that enables inter-vehicle communication in the 3GPP release-16.

Currently, research and standardization work on a network relay communication using direct communication between adjacent terminals within a certain region are being actively conducted by the 3GPP to improve the connectivity and service quality of the 5G communication network. In this regard, relay communication may have the following characteristics.
Relay structure based on NR-based PC5
Network structure supporting proximity-based services (ProSe)
Specifications, etc. related to quality-of-service (QoS), which apply the contents applied to PC5 as a baseline

In the 3GPP NR, the relay service may be classified into three types of scenarios. The first scenario may be an in-coverage scenario in which a network directly controls resources used for the relay service. In such an in-coverage scenario, the network may directly allocate a specific resource to be used for the relay service to a terminal performing the relay service. In addition, in the in-coverage scenario, the network may allocate a resource pool from which the terminal performing the relay service can select a resource and use the selected resource for the relay service. This scheme may have features that can avoid interference between wireless communications and optimize direct communications.

The second scenario may be an out-of-coverage scenario. In such an out-of-coverage scenario, the network may not be able to perform direct controls related to the relay communication or may not perform control functions. In the out-of-coverage scenario, the relay terminal may perform a relay communication function by using preconfigured relay communication-related resources and configuration parameters.

Finally, there may be a partial-coverage scenario. In such a partial-coverage scenario, the network may allocate resources to a relay terminal which is an in-coverage terminal. However, in the partial-coverage scenario, the network may not be able to allocate a resource to an out-of-coverage terminal. Accordingly, an out-of-coverage terminal may utilize preconfigured relay communication resources and configuration parameters. In this case, careful coordination may be required between network-controlled relay resources and preconfigured relay resources.

In the above-described service scenarios, a Uu connection between the relay terminal and the base station may use an NR Uu link, and a PC5 connection between the remote terminal and the relay terminal may use an NR sidelink.

FIG. 3 is a conceptual diagram illustrating a first exemplary embodiment of a 5G NR technology-based relay system.

Referring to FIG. 3, a 5G NR technology-based relay system may include a remote terminal 310, a relay terminal 320, a base station 330, a 5G core network (5GC) 340, and a data network (DN) 350. Here, the remote terminal 310 and the relay terminal 320 may be connected by an NR PC5, and the relay terminal 320 and the base station 330 may be connected by an NR Uu. According to definitions of the relay-related contents of the 3GPP, when the remote terminal 310 accesses a network entity such as the base station 330 through the relay terminal 320 and receives a communication service, the communication service provided by the relay terminal 320 may be defined as a ‘network relay service’.

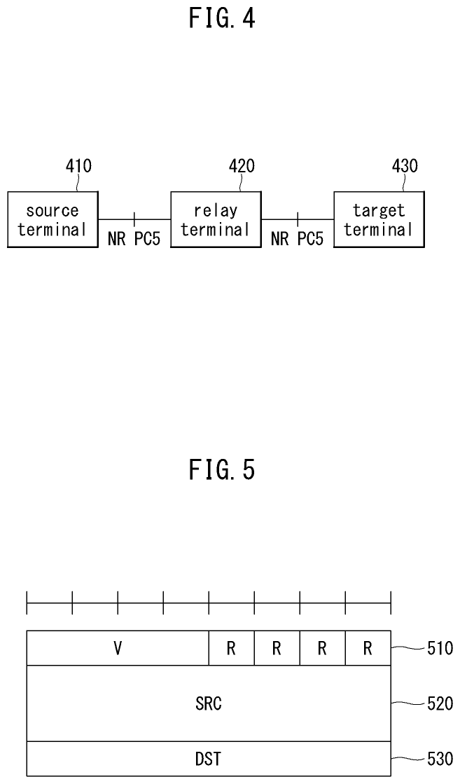

FIG. 4 is a conceptual diagram illustrating a second exemplary embodiment of a 5G NR technology-based relay system.

Referring to FIG. 4, a 5G NR technology-based relay system may include a source terminal 410, a relay terminal 420, and a target terminal 430. Here, the source terminal 410 and the relay terminal 420 may be connected by an NR PC5, and the relay terminal 420 and the target terminal 430 may be connected by an NR PC5. According to definitions of the relay-related contents of the 3GPP, when the source terminal 410 accesses the target terminal 430 through the relay terminal 420 and receives a communication service, the communication service provided by the relay terminal 420 to the source terminal 410 may be defined as a ‘terminal relay service’.

Meanwhile, in the above-described 5G NR technology-based relay system, a procedure for providing a relay service in a relay service function utilizing direct communication between terminals may be as follows.

1. Through a registration process, each terminal may register relay service-related information in the network.

2. Through an authentication process, each terminal may acquire rights and parameters related to a relay service.

3. A discovery process for the relay service may be performed.

4. A remote terminal desiring to receive the relay service may perform a process of selecting an adjacent relay terminal.

5. The remote terminal desiring to receive the relay service may perform a process of accessing the selected relay terminal.

6. The relay terminal that has received a relay service request may perform necessary network-related processing.

7. The relay terminal may perform connection establishment for performing the relay service.

8. The relay terminal may initiate the relay service for the remote terminal.

Meanwhile, when control processes according to normal base station processing are not performed due to an access failure or a certain situation of the base station, the remote terminal desiring to receive the relay service may omit the initial registration and authentication process through the network. Then, the remote terminal may first perform the registration and authentication process with the relay terminal by using preconfigured values (i.e., basic service configuration parameters), and then the remote terminal may perform a network-related process after completing the process of accessing the relay terminal. The remote terminal may re-perform the registration and authentication process with the network in the network-related process. In addition, the remote terminal may update relay service-related information related to the registration and authentication process processed by the basic service configuration parameters.

The main identification information used to identify each terminal in relation to the relay service may be as follows.

Relay service code: The relay service code may be an identifier used to identify the relay service.

Terminal identifier (UE ID): The terminal identifier may be an identifier for identifying each terminal. The terminal identifier may be used for direct communication and may be a value associated with the relay service code. The relay system may apply a unique terminal identifier to each terminal, which corresponds to the relay service code used for the relay service.

User information: The user information may be information for identifying a user, which is used in the discovery process. The user may be a provider or beneficiary of the relay service, and the user information may be an identifier for the user.

Application layer ID: The application layer ID may be an identifier used by an application layer to identify a terminal participating in the relay service.

Each terminal transmitting information through direct communication may use a unique connection layer identifier such as a layer 2 (L2) identifier as a terminal identifier. Through this, the terminal exchanging information through direct communication may identify a transmitter/receiver of a packet transmitted over a PC5 interface. That is, a frame transmitted through direct communication may include L2 identifiers of a transmitter and a receiver. The terminal may distinguish each frame by using the L2 identifiers. The terminal may maintain the L2 identifier to be unique in a direct communication environment within a region. If a collision occurs due to overlapping allocation of an L2 identifier used by an adjacent terminal and its own L2 identifier, the collision may be resolved by allocating a new L2 identifier. A source L2 identifier may always be self-assigned by a terminal that starts transmission of an L2 frame. An L2 identifier of a corresponding target may be identified by the application layer ID. In addition, the L2 identifier may be acquired during a PC5 link establishment process, from information of previous communication performed for the same application layer ID, or from a service announcement of the application layer. By managing a correspondence relationship between the application layer ID and the L2 identifier, the terminal may change the L2 identifier without interruption of the application service when necessary.

Meanwhile, a terminal desiring to participate in the relay service may, after performing the registration and authentication process, perform a discovery process in order to acquire information on the existence of other terminals adjacent to the terminal and relay service-related information on the adjacent terminals. The terminal may acquire application layer information in order to perform the discovery process. The application layer information may be received from an application server, or preconfigured values may be used as the application layer information. In the discovery process, a relay terminal desiring to provide the relay service may provide relay service-related information to adjacent terminals. In addition, in the discovery process, the remote terminal may receive the relay service-related information provided by the relay terminal. When the relay service is required, the remote terminal may access the corresponding relay terminal based on the received information.

In a discovery process according to a different scheme, the remote terminal may request a relay service by providing information related to the relay service required by the remote terminal to adjacent relay terminal(s). Accordingly, relay terminal(s) may receive, from the remote terminal, the request and the information related to the relay service. Then, in response to the request of the remote terminal, the relay terminal may reply with information on whether the required relay service can be provided.

In the above-described discovery process, the remote terminal and the relay terminal may identify the L2 identifiers used for connection establishment, and use them to identify the remote terminal and the relay terminal participating in the relay service. Meanwhile, the remote terminal may acquire information related to the existence of adjacent relay terminals through the discovery process and may perform a selection process for determining a relay terminal to perform the relay service based on the information. According to the latest 3GPP relay service-related agreements, the remote terminal may consider the following items in the process of selecting the relay terminal supporting the relay service.
Quality of a PC5 radio connection provided by the relay terminal
Details of the relay service provided by the relay terminal
Group that the relay terminal can relay
Network information related to the relay service
Information of the relay terminal preconfigured in the remote terminal

Basically, the remote terminal may preconfigure a PC5 connection quality related to connections between terminals. Alternatively, when the PC5 connection quality satisfies a certain threshold condition provided by the network, the corresponding relay terminal may be regarded as satisfying requirements suitable for the relay service. If the connection quality between the remote terminal and the relay terminal does not satisfy the configured threshold condition during the relay service, the remote terminal may stop the relay service through the relay terminal. In addition, the remote terminal may perform a reselection process for other adjacent relay terminals in order to secure a smooth relay service.

If there are a plurality of candidate relay terminals capable of satisfying the relay service requirements, the remote terminal may select a relay terminal having the best condition. The 3GPP specifications may specify details related to the selection of an optimal terminal as optional information. In addition, according to the 3GPP specifications, a terminal that satisfies a higher layer condition and has the best PC5 connection quality among a plurality of candidate relay terminals that satisfy predetermined requirements may be selected as a relay terminal.

The remote terminal that has performed the discovery and selection process may prepare for the relay service by performing an access process and network processing for establishing a connection with the selected relay terminal. For the access, the remote terminal may transmit, to the selected relay terminal, a direct communication request message including the terminal ID of the relay terminal (e.g., L2 identifier of the relay terminal), user information related to the relay service, and information related to the relay service through the PC5 interface, thereby initiating a connection procedure for the relay service. In this case, the remote terminal and the relay terminal may be distinguished by using the L2 identifiers. In response to the direct communication request of the remote terminal, the relay terminal, which has been monitoring a remote access request, may verify whether the L2 identifier included in the received request message matches its own L2 identifier. The relay terminal may regard it as a normal request when the L2 identifier of the relay terminal included in the request message matches its own L2 identifier. The relay terminal may notify that the request has been approved by returning an approval message corresponding to the request message to the remote terminal.

As described above, when the remote terminal and the relay terminal transmit messages related to the relay service, a terminal transmitting a message may provide the identifier of the terminal and the identifier of a terminal or group that is a target of the transmitted message in the message to specify a transmitter and a receiver of the message. In this case, the L2 identifier of the terminal or group may be composed of 24 bits. A protocol data unit (PDU) used for transmission of the message may conform to a form of a general media access control

(MAC) PDU and may include a sidelink shared channel (SL-SCH) subheader for relay communication. Here, the SL-SCH subheader may include a terminal ID (i.e., source, SRC) of the source terminal transmitting the message, a terminal ID (i.e., destination, DST) of the target terminal that is the target of the message, and a version number (i.e., version, V). The lower 8 bits in the terminal ID of the source terminal may be used as control channel information for filtering data packets in the physical layer. The remaining upper 16 bits of the terminal ID of the source terminal may be used for identifying the source terminal in the MAC layer. On the other hand, the lower 16 bits of the terminal ID of the target terminal may be used as control channel information for filtering data packets in the physical layer, and the remaining upper 8 bits may be used for identifying the target terminal. By using these terminal IDs, the terminals may examine the suitability of the message received at the MAC layer, and if they do not match, the corresponding message may be deleted.

FIG. 5 is a structural diagram illustrating a first exemplary embodiment of an SL-SCH subheader.

Referring to FIG. 5, in the SL-SCH lower header, the first octet 510 may include a 3-bit version (V) field and four 1-bit reservation (R) fields, the second and third octets 520 may include the identifier (SRC) of the source terminal, and the fourth octet 530 may include the identifier (DST) of the target terminal. The size of the SL-SCH subheader may be fixed.

Meanwhile, a PDU of the MAC layer, used for data transmission of the relay service, may include one SL-SCH subheader and one or more MAC subPDUs. Each MAC subPDU may be configured in one of the following forms, and the length of a MAC service data unit (SDU) may be variable.
One MAC subheader including padding
One MAC subheader and a MAC SDU
One MAC subheader and a MAC control element (CE)
One MAC subheader and padding

The MAC subheader excluding padding may be composed of four header fields: a reserved (R) field, a format (F) field, a logical channel ID (LCID) field, and a length (L) field. The MAC CE and the MAC subheader for padding may be composed of two header fields including a reserved (R) field and a logical channel identifier (LCID) field. An SL MAC subPDU including a MAC subSDU may be arranged after an SL-SCH subheader and before a MAC subPDU with a MAC CE and a MAC subPDU including padding in the MAC PDU. The SL MAC subPDU including the MAC CE may be arranged after all MAC subPDUs including the MAC SDU and before the MAC subPDU including the padding of the MAC PDU. The size of the padding may be 0.

In the MAC subheader, the length (L) field may indicate the byte-unit length of the MAC SDU, and the logical channel identifier (LCID) field may identify a logical channel instance or a type of the MAC CE within a range of a pair of the source L2 identifier and the target L2 identifier of the MAC SDU or padding.

It may be assumed that the relay service currently being discussed is basically in a state in which the remote terminal and the relay terminal secure connectivity with the base station in the in-coverage scenario. That is, it may be assumed that the relay service-related operation performed while the terminal is connected to the network is controlled by a relay service-related server. Therefore, in the relay system, latency in configuration and processing for the relay terminal and the remote terminal may be an important consideration.

In the case of an ultra-high frequency communication service utilizing a millimeter-wave band, a change in connection quality may be severe due to factors such as a change in a wireless channel-related environment within a service coverage, mobility of the terminal, and a communication environmental change caused by surrounding vehicles. Therefore, the relay system may frequently apply and adjust factors related to the quality and state of the relay service in order to properly respond to such an environment where the communication service is changed. Meanwhile, the reflection of these requirements may be basically for the entire network and may be based on a structure that requires centralized control. Accordingly, the relay system may act as an extreme system load on the network when the relay service processing frequently occurs in order to reliably provide the relay service. In addition, such a problem may act as a factor affecting the overall communication service quality. Accordingly, the relay system may require a reliable relay service control and processing method to cope with dynamic environmental changes.

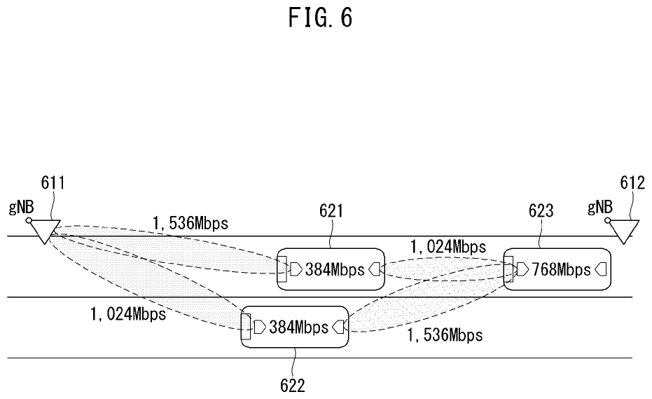

FIG. 6 is a conceptual diagram illustrating a first exemplary embodiment of a wireless relay communication configuration system.

Referring to FIG. 6, a wireless relay communication configuration system may include a first base station 611, a second base station 612, a first terminal 621, a second terminal 622, and a third terminal 623, and may form a millimeter wave-based public Wi-Fi service platform for public transportation. Here, the base stations 611 and 612 may be arranged at regular intervals on a road to be serviced. In addition, the base stations 611 and 612 may have respective communication coverages. The base stations 611 and 612 may perform beamforming technology-based data transmission to the terminals 621 to 623 moving within the communication coverages by using a very high-frequency band. Therefore, the terminals 621 to 623 receiving the millimeter wave-based public Wi-Fi service for public transportation may experience a communication failure due to the surrounding environments and obstacles occurring in transmission paths between the terminals 621 to 623 and the base stations 611 to 612. When such a communication failure occurs, the corresponding terminal may configure a relay communication path through an adjacent terminal. By receiving a relay service in this manner, the terminals 621 to 623 may secure seamless connectivity, thereby increasing the reliability of communication services. For example, when communication with the first base station 611 is interrupted due to movement, the third terminal 623 may utilize the first terminal 621 or the second terminal 622 as a relay terminal to perform communication with the first base station 611. Accordingly, the first terminal 621 may be a first relay terminal, the second terminal 622 may be a second relay terminal, and the third terminal 623 may be a remote terminal.

Here, a communication connection quality between the first base station 611 and the first terminal 621 may have a transmission rate of 1,536 Mbps. Accordingly, an available resource amount for the first terminal 621 in a communication service through the first base station 611 may be 1,536 Mbps. In addition, a required resource amount for the first terminal 621 itself may be 384 Mbps. Meanwhile, a communication connection quality between the first base station 611 and the second terminal 621 may have a transmission rate of 1,024 Mbps. Accordingly, an available resource amount for the second terminal 622 in a communication service through the first base station 611 may be 1,024 Mbps. In addition, a required resource amount for the second terminal 622 itself may be 384 Mbps.

Meanwhile, a direct communication connection quality between the first terminal 621 and the third terminal 623 may have a data rate of 1,024 Mbps. In addition, a direct communication connection quality between the second terminal 622 and the third terminal 623 may have a data rate of 1,536 Mbps. In this case, when the third terminal 623 uses a relay service, an expected resource amount for the entire relay service may be 768 Mbps, an expected resource amount for a network relay service may be 512 Mbps, and an expected resource amount for a terminal relay service may be 256 Mbps.

Meanwhile, the relay terminal and the remote terminal participating in the relay service may identify individual entities in the relay service by using the terminal IDs for the respective terminals. In this process, each terminal may uniquely generate a connection layer identifier corresponding to a relay service code and use it as the terminal ID. As described above, the connection layer identifier generated corresponding to the relay service code may be referred to as a ‘relay information-reflected identifier’ or a ‘relay information identifier’. In addition, the relay information-reflected identifier or the relay information identifier may be defined as a remote terminal identifier for the remote terminal, or may be defined as a relay terminal identifier for the relay terminal. Each terminal may generate and utilize the connection layer identifier by reflecting relay service-related information of each terminal for efficient relay communication configuration and processing.

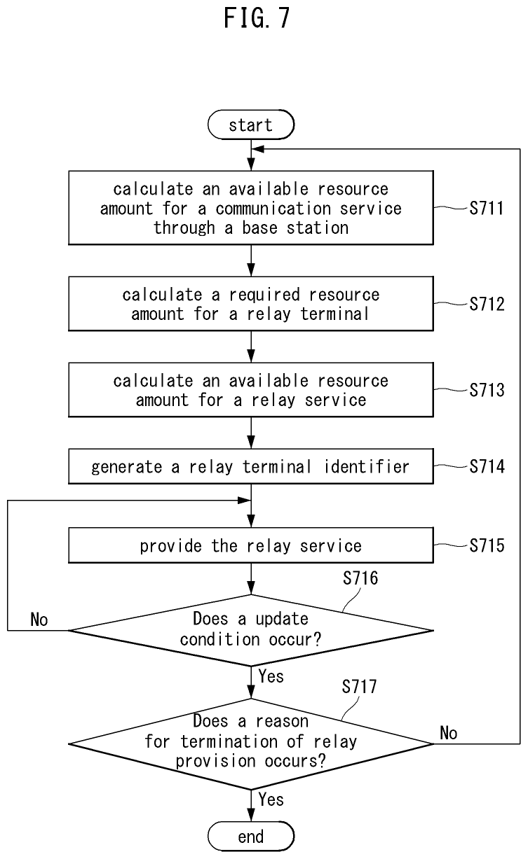

FIG. 7 is a flowchart illustrating a first exemplary embodiment of a relay information processing method of a relay terminal in a wireless relay communication configuration system.

Referring to FIG. 7, in a relay information processing method of a relay terminal of the wireless relay communication configuration system, a relay terminal desiring to provide a relay service may measure a connection quality between the relay terminal and a base station to calculate an available resource amount in a communication service through the base station (S711). In this case, the relay terminal may calculate the available resource amount for the communication service by estimating the maximum available network-based communication service quality in a communication path through the corresponding base station. Thereafter, the relay terminal may calculate a required resource amount of the relay terminal (S712). Here, the required resource amount (i.e., the amount of resources required by the relay terminal itself) may include the amount of resources occupied by a relay service being serviced when there is an existing relay service in service and the amount of resources used for a communication service provided by the relay terminal itself.

Thereafter, when the calculation of the available resource amount and the required resource amount is completed, in response to a network relay service request of a new remote terminal, the relay terminal may calculate an available resource amount for a relay service that can be used in addition to a current network relay service based on a Uu connection (S713).

Then, the relay terminal may generate a relay terminal identifier reflecting relay provision-related information (i.e., available resource amount for communication service, required resource amount, available resource amount for relay service, etc.) (S714). Then, the relay terminal may provide a relay service to the remote terminal existing in the vicinity by using the relay terminal identifier reflecting the relay provision-related information (S715).

Here, the process of providing the relay service will be described in detail with reference to FIG. 6 again. For example, it may be assumed that the total expected resource amount of the remote terminal 623 may be 768 Mbps, the expected resource amount for the network relay service thereof may be 512 Mbps, and the expected resource amount for the terminal relay service thereof may be 256 Mbps. In the case of the first relay terminal 621, the available resource amount for the communication service through the first base station 611 may be 1,536 Mbps. In the case of the first relay terminal 621, the required resource amount for the relay terminal itself may be 384 Mbps. Accordingly, the available resource amount for the relay service that the first relay terminal 621 can use to provide the network relay service to the remote terminal 623 may be 1,152 Mbps. Assuming that the first relay terminal 621 provides the network relay service to the remote terminal 623 by using 512 Mbps, if 512 Mbps is excluded, the amount of free resources that can be additionally provided for the network relay service for the remote terminal 623 or other remote terminals may be 640 Mbps. In addition, the available resource amount for a direct communication path between the first relay terminal 621 and the remote terminal 623 may be 1,024 Mbps. Assuming that the first relay terminal 621 provides the network relay service and the terminal relay service to the remote terminal 623, the amount of free resources that can be additionally provided to the direct path may be 256 Mbps.

In the case of the second relay terminal 622, the available resource amount for the communication service through the first base station 611 may be 1,024 Mbps. In the case of the second relay terminal 622, the required resource amount for the relay terminal itself may be 384 Mbps. Accordingly, the resource amount for the relay service that the second relay terminal 622 can provide to the remote terminal 623 may be 640 Mbps. Assuming that the second relay terminal 622 provides the network relay service to the remote terminal 623 by using 512 Mbps, if 512 Mbps is excluded, the amount of free resources that can be additionally provided for the network relay service for the remote terminal 623 or other remote terminals may be 128 Mbps.

In addition, the available resource amount for a direct connection path between the second relay terminal 622 and the remote terminal 623 may be 1,536 Mbps. Assuming that the network relay service and the terminal relay service are provided to the remote terminal 623, the amount of free resources that can be additionally provided to the direct path may be 768 Mbps.

In the case of the existing relay terminal selection scheme, the second relay terminal 622 having the direct path quality of 1,536 Mbps may be evaluated as being superior to the first relay terminal 621 having the direct path quality of 1,024 Mbps, and thus the remote terminal 623 may select the second relay terminal 622 as the relay terminal for the remote terminal. However, in the case of a proposed method, the remote terminal 623 may select the relay terminal through the available resource amount for the relay service that reflects complex evaluation of the amount of free resources for each path. To this end, the available resource amount for the relay service, which is provided by the relay terminal 621 or 622 to the remote terminal 623, may be as follows. Here, assuming that a weight of a network relay path is Wn, a weight of a direct path is Wd, the amount of free resources for the network relay service is Rn, and the amount of free resources for the direct path is Rd, the available resource amount Rs for the relay service may be calculated as in Equation 1 below.

R_{S}=Wₙ×Rₙ+W_{d}×R_{d} [Equation 1]

In this case, the weights may be fixed values by configuration. In addition, each of the weights may be a ratio value of the network relay service and the terminal relay service with respect to the total expected resource amount of the remote terminal 623.

Accordingly, when the total expected resource amount of the remote terminal 623 may be 768 Mbps, the expected resource amount for the network relay service thereof may be 512 Mbps, and the expected resource amount for the terminal relay service thereof may be 256 Mbps, the network relay path weight may be about 0.67, and the direct path weight may be about 0.33. In this case, the final available resource amount for the relay service of each of the relay terminals 621 and 622 may be calculated using Equations 2 and 3 below.

Available resource amount for relay service of first relay terminal=0.67×640+0.33×256=512 Mbps [Equation 2]

Available resource amount for relay service of second relay terminal=0.67×128+0.33×768=341 Mbps [Equation 3]

In addition, each of the relay terminals 621 and 622 may generate a relay terminal identifier reflecting such the relay provision-related information (i.e., available resource amount for communication service, required resource amount, available resource amount for relay service, etc.). In addition, each of the relay terminals 621 and 622 may provide the relay terminal identifier reflecting the relay provision-related information to the adjacent remote terminal 623. In this case, the remote terminal 623 may receive the relay terminal identifiers from the remote terminals 621 and 622 and calculate the available resource amount for the relay service using the relay provision-related information included in the relay terminal identifiers.

In this case, since the available resource amount for the relay service of the first relay terminal 621 is 512 Mbps and the available resource amount for the relay service of the second relay terminal 622 is 341 Mbps, the remote terminal 623 may determine that a relatively better relay service environment can be provided by the first relay terminal 621 compared to the second relay terminal 622. In this case, the remote terminal 623 may select the first relay terminal 621 as a final relay terminal, and may request the first relay terminal 621 to process the relay service. In this case, the remote terminal 623 may request the relay service by generating a remote terminal identifier reflecting the expected resource amount for the network relay service and transmitting it to the first relay terminal 621. Then, the first relay terminal 621 may calculate the expected resource amount for the network relay service based on the remote terminal identifier, and if the expected resource amount for the network relay service is less than the available resource amount for the relay service, the first relay terminal 621 may provide the relay service.

On the other hand, when the total expected resource amount of the remote terminal 623 is 768 Mbps, the expected resource amount for the network relay service is 256 Mbps, and the expected resource amount for the terminal relay service is 512 Mbps, the following procedure may be performed.

First, the first relay terminal 621 may have the available resource amount of 1,536 Mbps for a communication service through the first base station 611. In the case of the first relay terminal 621 as described above, the required resource amount for the relay terminal itself may be 384 Mbps. Accordingly, the available resource amount for the relay service that the first relay terminal 621 can use to provide the network relay service to the remote terminal 623 may be 1,152 Mbps. Assuming that the network relay service is provided to the remote terminal 623 by using 256 Mbps, if 256 Mbps is excluded, the amount of free resources for the network relay service that can be additionally provided to the network relay service for the remote terminal 623 or other remote terminals may be 896 Mbps. In addition, the available resource amount for the direct connection path between the first relay terminal 621 and the remote terminal 623 may be 1,024 Mbps. Assuming that the network relay service and the terminal relay service are provided to the remote terminal 623, the amount of free resources that can be additionally provided to the direct path may be 256 Mbps.

The available resource amount that can be used by the second relay terminal 622 for a communication service through the first base station 611 may be 1,024 Mbps. In the case of the second relay terminal 621, the required resource amount for the relay terminal itself may be 384 Mbps. Accordingly, the available resource amount for the relay service of the second relay terminal 622 for the remote terminal 623 may be 640 Mbps. Assuming that the network relay service is provided to the remote terminal 623 by using 256 Mbps, if 256 Mbps is excluded, the amount of free resources for the network relay service that can be additionally provided to the network relay service for the remote terminal 623 or other remote terminals may be 384 Mbps.

In addition, the available resource amount that can be used for the direct connection path between the second relay terminal 622 and the remote terminal 623 may be 1,536 Mbps. Assuming that the network relay service and the terminal relay service are provided to the remote terminal 623, the amount of free resources that can be additionally used for the direct path may be 768 Mbps. The weight of the network relay path may be about 0.33, and the weight of the direct path may be about 0.67. In this case, the final resource amount the can be used by the relay service of the relay terminals 621 and 622 may be calculated as shown in Equations 4 and 5 below.

Available resource amount for relay service of first relay terminal=0.33×896+0.67×256=469 Mbps [Equation 4]

Available resource amount for relay service of second relay terminal=0.33×384+0.67×768=640 Mbps [Equation 5]

In addition, each of the relay terminals 621 and 622 may generate a relay terminal identifier reflecting such relay provision-related information (i.e., available resource amount for communication service, required resource amount, available resource amount for relay service, etc.). In addition, each of the relay terminals 621 and 622 may provide the relay terminal identifier reflecting the relay provision-related information to the adjacent remote terminal 623. In this case, the remote terminal 623 may receive the relay terminal identifiers, and may calculate the available resource amount for the relay service by subtracting the required resource amount from the available resource amount for the communication service based on the relay provision-related information included in the relay terminal identifiers. In this case, since the available resource amount for the relay service of the first relay terminal 621 is 469 Mbps and the available resource amount for the relay service of the second relay terminal 622 is 640 Mbps, the remote terminal 623 may determine that a relatively better relay service environment can be provided by the second relay terminal 622 compared to the first relay terminal 621. In this case, the remote terminal 623 may select the second relay terminal 622 as a final relay terminal, and may request the second relay terminal 622 to process the relay service. In this case, the remote terminal 623 may generate a remote terminal identifier reflecting the expected resource amount for the network relay service and may request the relay service by transmitting the remote terminal identifier to the second relay terminal 622. Then, the second relay terminal 622 may calculate the expected resource amount for the network relay service based on the remote terminal identifier, and if the expected resource amount for the network relay service is less than the available resource amount for the relay service, the second relay terminal 622 may provide the relay service.

Referring again to FIG. 7, while providing such the relay service, the relay terminal may determine whether a condition for updating the relay provision-related information occurs (S716). That is, the relay terminal may perform the corresponding procedure when a change in a related service quality index satisfies an update condition of the relay provision-related information while providing the relay service to the remote terminal. Here, the update condition of the relay provision-related information may be a case where a factor related to the relay service provision changes by more than a configured threshold. In this regard, the update condition of the relay provision-related information may include, for example, the following.

(1) When there is a large change in the quality of the Uu connection (i.e., when the change in the available resource amount for the communication service becomes greater than or equal to a first threshold due to a change in the connection quality between the relay terminal and the base station)

(2) When the amount of resources used by the relay terminal itself changes rapidly

(3) When the required resource amount of the relay terminal changes significantly due to the change in the amount of occupied resources due to termination of the previously provided relay service (i.e., when the change in the required resource amount of the relay terminal becomes greater than or equal to a second threshold)

The relay terminal may determine whether a situation for satisfying the update condition of the relay provision-related information occurs, and when the situation for satisfying the update condition of the relay provision-related information occurs, the relay terminal may determine whether a reason for termination of the relay provision occurs (S717). Here, the reason for termination of the relay provision may be as follows.

(1) When the remote terminal requests termination of the relay service

(2) When the available resource amount of the corresponding remote terminal is lower than a certain threshold due to deterioration of the connection quality between the base station and the relay terminal

(3) When the available resource amount of the remote terminal is lower than a certain threshold due to an increase in the relay terminal's own communication service requirements

(4) When the available resource amount of the remote terminal falls below a certain threshold due to a relay service for another remote terminal of higher priority

Describing (1) to (4) again with reference to FIG. 6, they may be described as follows. First, the case (1) may occur when the remote terminal 623 moves out of a shadow area while receiving the relay service. In addition, the case (1) may occur when the remote terminal 621 can smoothly connect to the first base station 611 as an obstacle existing in a propagation path between the remote terminal 621 and the first base station 611 disappears. In this case, the remote terminal 623 may directly receive the communication service that has been provided by the first base station 621 via the relay terminal 622 or 623. In this case, the remote terminal 623 may request the corresponding relay terminal 622 or 623 to terminate the corresponding relay service. The corresponding relay terminal 622 or 623 receiving the termination request may terminate the relay service provided to the remote terminal 623.

The case (2) may occur, for example, when the available resource amount for the network relay service is reduced to 512 Mbps due to deterioration of the connection quality between the base station and the first relay terminal 621, the required resource amount 384 Mbps is preferentially allocated from the available resource amount for the network relay service, and the remaining resource amount becomes 128 Mbps which is less than the expected resource amount of the remote terminal 623. The case (3) may occur when the required resource amount for the first relay terminal 621 itself increases from 384 Mbps to 1,408 Mpbs, the required resource amount for the first relay terminal itself is preferentially allocated, and the remaining resource amount becomes 128 Mbps which is less than the expected resource amount of the remote terminal 623. The case (4) may occur when another remote terminal having a service priority over the remote terminal 623 requests a relay service having a required network relay resource amount of 1,024 Mbps from the first relay terminal 621, the first relay terminal 621 applies a principle of allocating it prior to the remote terminal 623, and the remaining available resource amount becomes 128 Mbps, which is less than the expected resource amount of the remote terminal 623.

Accordingly, as in the above cases (2) to (4), the relay terminal 621 or 622 may regard the case where the available resource amount becomes less than a certain threshold in providing the relay service to the remote terminal 623 as a situation in which a service requirement is not satisfied, and may determine that the case corresponds to a relay service termination condition.

Referring again to FIG. 7, if a relay service termination condition is determined to occur as a result of determining whether or not the relay service termination condition occurs, the relay terminal may generate a relay terminal identifier reflecting new relay provision-related information and utilize the generated relay terminal identifier for the relay service by performing the steps from the step S711 again. On the other hand, when a reason for termination of relay provision occurs, the relay terminal may terminate the relay service. Meanwhile, the relay terminal may continue to provide the relay service if, as a result of determining whether a situation satisfying the update condition of the relay provision-related information occurs, the situation for satisfying the update condition of the relay provision-related information does not occur (S716). Meanwhile, the available resource amount, the required resource amount, the occupied resource amount, and the used resource amount may be expressed as a transmission rate, and a unit of the transmission rate may be Mbps.

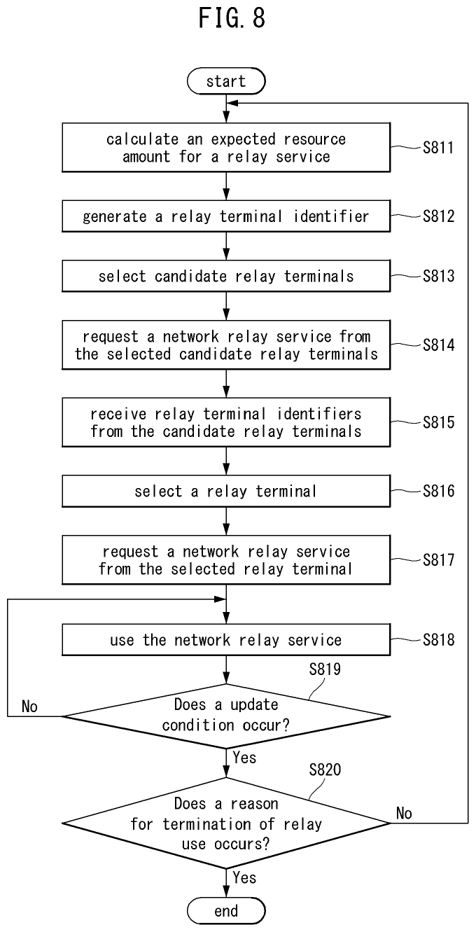

FIG. 8 is a flowchart illustrating a first exemplary embodiment of a relay information processing method of a remote terminal in a wireless relay communication configuration system.

Referring to FIG. 8, in a relay information processing method of a remote terminal of a wireless relay communication configuration system, when the remote terminal is provided by a relay terminal with a relay service, the remote terminal may calculate the expected required resource amount for the entire relay service (S811). In this case, the relay service may be largely classified into a network relay service and a terminal relay service. Accordingly, the remote terminal may calculate the expected resource amount for the network relay service and the expected resource amount for the terminal relay service. Thereafter, the remote terminal may generate a remote terminal identifier reflecting relay use-related information (S812). The remote terminal may select terminals capable of providing the network relay service from among adjacent terminals as candidate relay terminals (S813). Then, the remote terminal may request provision of the network relay service by transmitting the generated remote terminal identifier reflecting the relay use-related information to the selected candidate relay terminals (S814).

In this case, when the remote terminal performs a discovery process, the remote terminal may provide the remote terminal identifier reflecting the relay use-related information to adjacent relay terminals as discovery message information. If the remote terminal does not perform the discovery process, the remote terminal may transmit a direct access request message including its arbitrarily configured identifier to the adjacent relay terminals, and then may provide the remote terminal identifier reflecting the relay use-related information to a relay terminal that has received the direct access request message wants to provide a relay function.

Accordingly, each of the candidate relay terminals may respond to the request of provision of the network relay service by transmitting a relay terminal identifier reflecting respective relay provision-related information to the remote terminal. Then, the remote terminal may receive the relay terminal identifiers from the candidate relay terminals (S815). If the remote terminal receives the relay terminal identifiers from the candidate relay terminals, which reflect the relay provision-related information, the remote terminal may select a candidate relay terminal having the best relay service quality as its relay terminal (S816).

Looking at this in more detail, the remote terminal may calculate the available resource amount for the communication service and the required resource amount based on each relay terminal identifier, and may calculate the available resource amount for the network relay service by using Equation 1. In this case, a candidate relay terminal corresponding to the relay terminal identifier corresponding to the largest value of the available resource amount for the network relay service may be selected as the relay terminal.

Once the relay terminal is selected, the remote terminal may request the selected relay terminal to provide the network relay service (S817). Then, the remote terminal may use the network relay service provided by the relay terminal (S818). Meanwhile, the remote terminal may determine whether a situation satisfying a update condition of the relay use-related information occurs while performing communication with the base station using the network relay service (S819). That is, the remote terminal may perform the corresponding procedure when a change of a related service quality index satisfies the update condition while receiving the relay service from the corresponding relay terminal. Here, the update condition of the relay use-related information may be a case in which a factor related to using the relay service changes by more than a configured threshold. In this regard, the update condition of relay use-related information may be, for example, (1) when a change in the expected resource amount for the network relay service is equal to or greater than a first threshold, (2) when a change in the expected resource amount for the terminal relay service is equal to or greater than a second threshold value, or the like.

The remote terminal may determine whether a situation satisfying the update condition of the relay use-related information occurs, and when a situation satisfying the update condition of the relay use-related information occurs, the remote terminal may determine whether a reason for termination of relay use occurs (S820). That is, the remote terminal may perform a termination procedure when a related service termination requirement is satisfied while receiving the relay service from the corresponding relay terminal. The reason for termination of relay use in the case of the remote terminal may be as follows.

(1) When a relay service termination condition of the remote terminal is satisfied

(2) When the relay terminal requests termination of the relay service

(3) When the available resource amount of the relay terminal falls below a certain threshold due to an increase in the required resource amount for the relay service of the remote termina

(4) When the available resource amount for the remote terminal falls below a certain threshold due to deterioration of a connection quality between the relay terminal and the remote terminal

Describing (1) to (4) again with reference to FIG. 6, they may be described as follows.

The case (1) may occur when the remote terminal 623 moves out of a shadow area while receiving the relay service. Alternatively, the case (1) may occur also when the remote terminal 623 is able to smoothly access the first base station 611 as an obstacle existing in a propagation path between the remote terminal and the base station disappears. In this case, the remote terminal 623 may directly receive the communication service that has been provided from the first base station 611 via the relay terminal 621 or 622. Alternatively, the case (1) may correspond to a case in which the remote terminal 623 can directly receive the communication service from the first base station 611 with a predetermined quality or higher. In this case, the remote terminal 623 may determine that the relay service termination condition is satisfied, and may request the relay terminal 621 or 622 to terminate the corresponding relay service. The relay terminal 621 or 622 receiving the termination request may terminate the relay service provided to the remote terminal 623.

Meanwhile, the case (2) may be a case in which the remote terminal 623 receives a relay service termination request from the relay terminal 621 or 622. During the relay service process, the relay terminal 621 or 622 may not be able to maintain the relay service due to deterioration of a connection quality between the base station and the relay terminal. In this case, the relay terminal 621 or 622 may request termination of the relay service for the remote terminal 623. Also, the case (2) may occur when the amount of resources that can be provided to the remote terminal 623 by the relay terminal 621 or 622 falls below a certain threshold due to an increase in the required resource amount for the relay terminal itself. In this case, the relay terminal 621 or 622 may request the remote terminal 623 to terminate the corresponding relay service. In addition, the case (2) may occur when the amount of resources that the relay terminal 621 or 622 can provide to the remote terminal 623 falls below a certain threshold according to a preferential service processing for other remote terminal(s) having a higher service priority than the remote terminal 623. The case (3) may occur when the expected resource amount of the remote terminal 623 is increased. For example, the expected resource amount for the terminal relay service of the remote terminal 623 may increase from 256 Mbps to 512 Mbps. In this case, the expected resource amount for the entire relay service of the remote terminal 623 may become 1,024 Mbps. In this case, the amount of available relay resources through the first relay terminal 6212 may fall below a certain threshold. Therefore, the remote terminal 623 may regard the case where the amount of available resources that can be used in receiving the relay service through the first relay terminal 621 becomes less than or equal to a configured threshold as a situation in which a service requirement is not satisfied, and may determine that the case corresponds to the relay service termination condition. The remote terminal 623 that has decided to terminate the relay service through the relay terminal 621 or 622 may perform a discovery process for another relay terminal that can satisfy the relay service quality required by the remote terminal 623.

The case (4) may be a case in which the available resource amount of the corresponding remote terminal 623 falls below a certain threshold due to deterioration of the connection quality between the relay terminal and the remote terminal. For example, the wireless communication environment may change according to the movement of the first relay terminal 621 and the remote terminal 623. Alternatively, a communication failure factor such as another moving object or structure may occur in the transmission path between the relay terminal 621 or 622 and the remote terminal 623. If such a problem occurs, the available resource amount for the direct communication path may be reduced from 1,024 Mbps to 512 Mbps. In this case, the remote terminal 623 may determine that the available resource amount is less than or equal to a threshold. According to this determination, the remote terminal 623 may decide to terminate the relay service through the relay terminal 621 or 622. The remote terminal 623 that has decided to terminate the relay service may perform a discovery process for another relay terminal that can satisfy the relay service quality required by the remote terminal 623.

On the other hand, if a reason for termination of relay use does not occur according to a result of determining whether a reason for termination of relay use occurs, the remote terminal may generate a remote terminal identifier reflecting new relay use-related information and utilize the generated remote terminal identifier for the relay service by performing the steps from the step S811 again. On the other hand, when a reason for termination of relay use occurs, the relay terminal may terminate the relay service after requesting termination of the network relay service from the relay terminal. Meanwhile, if a situation satisfying the update condition of the relay use-related information does not occur according to a result of determining whether a situation satisfying the update condition of the relay use-related information occurs, the remote terminal may continue to use the network relay service (S818). Meanwhile, the expected resource amount may be expressed as a transmission rate, and a unit of the transmission rate may be Mbps.

Meanwhile, the connection layer identifier of the terminal generated by the terminal in relation to the relay service may be configured as follows to reflect service and performance-related characteristics related to the relay service. Here, the connection layer identifier may be the relay information-reflected identifier or the relay information identifier. In this case, the relay information-reflected identifier or the relay information identifier generated by the remote terminal identifier, and the relay information-reflected identifier or the relay information identifier generated by the relay terminal may be the relay terminal identifier. In addition, the relay information-reflected identifier or the relay information identifier may be composed of a upper layer (i.e., L2) identifier and a lower layer (i.e., physical layer) identifier. Table 1 may show a configuration of the relay information-reflected identifier or the relay information identifier.

TABLE 1

| Information elements | Type/reference | Length (bits) |
|---|---|---|
| Message Header | Message Type | 4 |
| Relay Capacity | Relay Capabilities | 5 |
| Ratio Code | Capacity Ratio | 4 |
| Duplication Code | Duplication Protection Code | 2 |
| Check Code | Check Code | 1 |
| Message Footer | Message Type | 8 |

Referring to Table 1, the first 4-bit field in the relay information identifier may be a message header field of a message type indicating whether a corresponding algorithm is applied. When the corresponding message header field is set to a specific value (e.g., 1111), it may indicate that the corresponding relay information identifier is an L2 identifier that reflects a primary performance indicator of relay communication for the corresponding terminal. When the message header field is not set to the specific value, the relay terminal or the remote terminal may regard the relay information identifier as a general L2 identifier, and may support a general relay service by performing a process related to the general relay service. The next 5-bit field may be a relay capacity field indicating a relay service quality level that can be provided for the relay service or a relay service quality level that can be requested for the relay service. In the relay terminal identifier, the relay capacity field may indicate the available resource amount for the communication service of the Uu connection secured by the relay terminal to provide the communication service, and may indicate a transmission rate by using a predefined index. In addition, in the remote terminal identifier, the relay capacity field may indicate the expected resource amount of the relay service required by the remote terminal, and may be expressed as an index for a predefined transmission rate. Table 2 may show an example of a transmission rate (TX rate) for each index.

TABLE 2

| | TX rate |
|---|---|
| Index | (Mbps) |
| 0 | 1 |
| 1 | 2 |
| 2 | 2 |
| 3 | 3 |
| 4 | 4 |
| 5 | 6 |
| 6 | 8 |
| 7 | 12 |
| 8 | 16 |
| 9 | 24 |
| 10 | 32 |
| 11 | 48 |
| 12 | 64 |
| 13 | 96 |
| 14 | 128 |
| 15 | 192 |
| 16 | 256 |
| 17 | 384 |
| 18 | 512 |
| 19 | 768 |
| 20 | 1,024 |
| 21 | 1,536 |
| 22 | 2,048 |
| 23 | 3,072 |
| 24 | 4,096 |
| 25 | 6,144 |
| 26 | 9,216 |
| 27 | 12,288 |
| 28 | 18,432 |
| 29 | 27,648 |
| 30 | 36,864 |
| 31 | 55,296 |

In Table 1, the 4-bit field after the relay capacity field may be a ratio code field indicating a capacity ratio. Here, from the point of view of the relay terminal, the ratio code may be a ratio of the required resource amount to the available resource amount for the communication service. In this manner, the ratio code field of the relay terminal identifier may indicate a ratio of the required resource amount for the relay terminal itself to the available resource amount that can be used for the entire communication services through the Uu connection. That is, the ratio code field of the relay terminal identifier may indicate (the required resource amount/the available resource amount for the communication services). Through this, the remote terminal may estimate the maximum service quality level of the network relay service that can be provided through the corresponding relay terminal. That is, the remote terminal may calculate the available resource amount for the relay service that the relay terminal can provide by using the relay capacity field and the ratio code field. On the other hand, from the point of view of the remote terminal, the ratio code field may indicate a ratio of the expected resource amount for the network relay service to the expected resource amount for the entire relay service. That is, the ratio code field of the remote terminal identifier may indicate a ratio of the expected resource amount for the network relay service to the expected resource amount for the entire relay service. That is, the ratio code field of the remote terminal identifier may be expressed as (the expected resource amount for the network relay service/the expected resource amount for the entire relay service). Through this, the relay terminal may estimate levels of the network relay service and the terminal relay service required by the remote terminal. In this case, when 4 bits are allocated to the ratio code field, the 4 bits may be used as a ratio of an index field value n to the total number of expressible values (e.g., index (n)/{2ⁿ−1}), or may be used as a ratio according to percentile value assignment. Here, n may be 4.

The next 2-bit field may be a duplication code field indicating a code (i.e., duplication protection code) for preventing duplication from occurring, and may be used as a terminal identifier to avoid a collision of identifiers that may occur for eight terminals within a corresponding service region. That is, if a plurality of terminals existing in the corresponding service region have the same relay capacity and rate code in the respective relay information identifiers, a collision of terminal identifiers may occur, and the duplication protection code may resolve the collision. The duplication code initially assigned and configured for relay service information exchange may be changed through identification information update after completion of the relay service processing, thereby avoiding identification resource exhaustion. In addition, the last 1-bit field among the upper layer fields may be a check code field expressing an error detection code for the corresponding 15-bit L2 identifier. The lower 8-bit field, which is a lower layer identifier region, may be a message footer field indicating whether relay information is reflected, which is similar to the message header of the upper layer identifier.

Meanwhile, with reference to FIG. 6, a configuration and configuration example of the relay information identifier may be described as follows. As a result of quality measurement for Uu connections, the maximum available resource amount for communication services through a path between the base station and each of the first and second relay terminals, the available resource amount for the first relay terminal 621 may be 1,536 Mbps, and the available resource amount for the second relay terminal 622 be 1,024 Mbps. It may be assumed that a sum of the required resource amount for a relay service currently being serviced by the first or second relay terminal and the required resource amount of the communication service provided by itself is 384 Mbps. The remote terminal 623 may have the expected resource amount of 768 Mbps, which is a service quality level required by the entire relay service. That is, the expected resource amount required for the network relay service may be 512 Mbps, and the expected resource amount required for the terminal relay service may be 256 Mbps. When the relay information-reflected identifier is the relay terminal identifier, a value of the relay capacity field of the identifier provided by the first relay terminal 621 may be 21, and a value of the relay capacity of the identifier provided by the second relay terminal 622 may be 20. On the other hand, when the relay information-reflected identifier is the relay terminal identifier, a value of the ratio code field of the identifier provided by the first relay terminal 621 may be 4, and a value of the ratio code field of the identifier provided by the second relay terminal 622 may be 6.

Looking at this in more detail, in case of the first relay terminal 621, the ratio code may be 384/1,536=0.25. In this case, the first relay terminal 621 may calculate an index n so that a value of (index (n)/{2^{(number of bits)}−1}) is closest to 0.25. Here, in case of n=4, a value 0.27 may be calculated, and thus 4 may be selected as an index. Then, the first relay terminal 621 may transmit a relay information-reflected identifier in which the ratio code field is set to 4 to the remote terminal 623. Then, the remote terminal 623 may recognize 1,126 Mbps, which is 1,536-1,536*(4/15), as the available resource amount for the relay service.

Similarly, in case of the second relay terminal 622, the ratio code may be 384/1,024=0.38. In this case, the second relay terminal 622 may calculate an index n so that a value of (index (n)/{2^{(number of bits)}−1) is closest to 0.38. Here, in case of n=6, a value 0.4 may be calculated, and thus 6 may be selected as an index. Then, the second relay terminal 622 may transmit a relay information-reflected identifier in which the ratio code is set to 6 to the remote terminal 623. Then, the remote terminal 623 may recognize 614 Mbps, which is 1,024-1,024*(6/15), as the available resource amount for the relay service.

In this example, the service quality that can be supported for the relay service, which the remote terminal 623 can estimate by using relay provision-related information (i.e., the relay capacity code and the ratio code) of the relay terminal identifier of the first relay terminal 621, may be a level of supporting a transmission rate of 1,126 Mbps. The service quality that can be supported for the relay service, which the remote terminal 623 can estimate by using relay provision-related information (i.e., the relay capacity code and the ratio code) of the relay terminal identifier of the second relay terminal 622, may be a level of supporting a transmission rate of 614 Mbps. Accordingly, the remote terminal 623 may identify that the first relay terminal 621 and the second relay terminal 622 satisfy a predetermined condition in relation to the network relay service required by the remote terminal 623, and may estimate that a margin of the available resource amount of the relay service for the network relay service of the first relay terminal 621 is larger than a margin of the available resource amount of the relay service of the second relay terminal 622. Accordingly, the remote terminal 623 may use the relay service by requesting the relay service from the first relay terminal 621.

Meanwhile, a value of the relay capacity field in the remote terminal identifier generated by the remote terminal 623 may be 19, and a value of the ratio code field thereof may be 10. Looking at this in more detail, the ratio code in the remote terminal identifier may be a value representing a ratio of the expected resource amount for the network relay service to the expected resource amount for the entire relay service (i.e., the expected resource amount for the network relay service+the expected resource amount for the terminal relay service). Accordingly, when the expected resource amount for the network relay service is 512 Mbps and the expected resource amount for the terminal relay service is 256 Mbps, the ratio value may be about 0.67 (i.e., 512/768). Accordingly, the remote terminal may calculate an index n so that a value of (index (n)/{2^{(number of bits)}−1}) is closest to 0.67. Here, n may be 10, a value may be 10/15≈0.67, and 10 may be selected as the index n. In addition, the remote terminal 623 may transmit a relay information-reflected identifier in which the ratio code is set to 10 to the first relay terminal 621 and the second relay terminal 622. Then, the first relay terminal 621 and the second relay terminal 622 may recognize 512 Mbps, which is 768*(10/15), as the available resource amount for the relay service. Accordingly, the first and second relay terminals 621 and 622 that have received this may estimate that the required resource amount of the network relay service for the remote terminal 623 is 512 Mbps and the required resource amount of the terminal relay service for the remote terminal 623 is 256 Mbps.

As described above, the relay terminal may perform a more efficient relay service processing by dynamically transmitting information on performance and configuration related to the relay service to the adjacent remote terminal by using the relay information-reflected identifier. In a service configuration procedure supporting the relay terminal-based discovery, when a plurality of relay terminals exist nearby, the remote terminal may identify characteristics and quality information of a relay service supported by each relay terminal by using relay communication service information reflected in relay information identifiers. Accordingly, the remote terminal may utilize the relay terminal identifier as a major consideration factor along with the connection quality between the remote terminal and the corresponding relay terminal.

Referring again to FIG. 6, when using the existing scheme of selecting an optimal relay terminal from among a plurality of relay terminals only in consideration of a direct communication path quality between the remote terminal 623 and each of the relay terminals, the second relay terminal having a direct connection path quality of 1,536 Mbps, not the first relay terminal having a direct connection path quality of 1,024 Mbps, may be selected as an optimal relay terminal for the remote terminal 623. In this case, both of the two relay terminals 621 and 622 may satisfy the quality level of the network relay service required by the remote terminal. However, the tolerance of the first relay terminal 621 for idle resources on the entire path may be greater than the tolerance of the second relay terminal 622 for idle resources on the entire path. Therefore, it may not be said that the second relay terminal 622 is an optimal relay terminal.

This is because, when the network quality of the second relay terminal 622 deteriorates on the relay path, the low tolerance of the second relay terminal 622 may act as a factor of service limitation and quality degradation due to a bottleneck. In addition, even when another remote terminal having a higher priority than the corresponding relay terminal appears, the low tolerance of the second relay terminal 622 may act as a factor of service limitation and quality degradation due to a bottleneck. In addition, when a change such as an increase in a transmission amount of the corresponding remote terminal occurs more than an allowable level, the low tolerance of the second relay terminal 622 may act as a factor of service limitation and quality degradation due to a bottleneck.

In this regard, in the case of FIG. 6, it may be assumed that the connection quality on the Uu path is reduced by 20%. In this case, the Uu connection quality of the first relay terminal 621 may be about 1,228 Mbps, and the Uu connection quality of the second relay terminal 622 may be about 819 Mbps. Assuming that a quality required by the first relay terminal 621 or the second relay terminal 622 itself or by a higher-priority relay service should be considered prior to the quality of the service for the remote terminal 623, the service quality that the first relay terminal 621 can support for the remote terminal 623 may be 819 Mbps, and the service quality that the second relay terminal 622 can support for the remote terminal 623 may be 436 Mbps.

Accordingly, it may be possible for the remote terminal 623 to continue the relay service through the network relay service path through the second relay terminal 622. However, the remote terminal 623 may not be able to receive the network access service of the level expected by the remote terminal from the second relay terminal 622, and the connection quality may be limited to the maximum level that the second relay terminal 622 can provide. In this case, the remote terminal 623 may accommodate the change of the relay communication service quality level through the corresponding path, and accommodate the overall degradation of the communication service quality of the remote terminal 623. Alternatively, the remote terminal 623 may release the corresponding relay connection when it is difficult to accommodate such the quality deterioration situation. In addition, the remote terminal 623 may perform a process of securing an alternative path through the first relay terminal 621 capable of providing the network relay service quality. In this case, the remote terminal 623 may have to accommodate a delay caused by the procedure of re-selecting and configuring a relay terminal. The remote terminal 623 may experience deterioration in overall service quality and system performance when the reselection and configuration procedure is not smoothly performed.

However, according to the proposed wireless relay communication configuration method, it is possible to utilize dynamically acquired relay quality information. Accordingly, the remote terminal having a requirement for the network relay service may consider not only the quality of the direct communication path between terminals but also the quality of the network relay path, which is a final relay service oriented point, in the selection process. As a result, the remote terminal may not one-dimensionally select a relay terminal having the highest direct communication quality with the remote terminal as an optimal relay terminal among a plurality of adjacent relay terminals as in the conventional scheme. The remote terminal may comprehensively determine the quality of the network relay path as well as the quality of the direct path, and may select an optimal relay terminal by efficiently determining a candidate relay terminal that has a high latitude, appropriately satisfies a connection quality of the direct communication path, and has an excellent network relay path quality. That is, through the above-described relay information providing scheme, the remote terminal may configure a more efficient and reliable relay service than the existing scheme.

In addition, when a change in the relay service quality occurs due to a change in quality of the communication path between the network and the relay terminal, termination of the existing relay service, initiation of another relay service, a change in the terminal's own requirements, or the like, the relay terminal may reflect such the change of the relay service to the relay terminal identifier. The relay terminal may provide a flexible and practical service indicator for the dynamically changing service environment by sharing the relay terminal identifier with neighboring terminals. In addition, the relay terminal may increase service efficiency and reliability by sharing the relay terminal identifier with neighboring terminals.

Meanwhile, in the relay information requesting scheme by the remote terminal, the relay terminal receiving the relay service request may determine whether to accept the request based on the current relay service status, and may omit the response if it is not possible to accept the request. In addition, the relay terminal may estimate a supportable quality level and transmit it to the remote terminal, so that the remote terminal can omit unnecessary processing in configuring the relay service. Also, the relay terminal may help the remote terminal to select an optimal path for the current service environment by estimating a supportable quality level and transmitting it to the remote terminal.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. An operation method of a relay terminal in a communication system, the operation method comprising:
calculating a first available resource amount of a communication service through a base station;
calculating a required resource amount for the relay terminal;
generating a relay terminal identifier reflecting the first available resource amount and the required resource amount, and providing the relay terminal identifier to a remote terminal; and
providing a relay service to the remote terminal when a request for the relay service is received from the remote terminal.

2. The operation method according to claim 1, further comprising:
determining whether an update condition for the relay terminal identifier occurs; and
when the update condition occurs, updating the relay terminal identifier according to the update condition.

3. The operation method according to claim 2, wherein the update condition is at least one of a case in which a change in the first available resource amount is equal to or greater than a first threshold and a case in which a change in the required resource amount is equal to or greater than a second threshold.

4. The operation method according to claim 1, wherein the providing of the relay service to the remote terminal comprises:
receiving, from the remote terminal, the request for the relay service including a remote terminal identifier reflecting an expected resource amount for a network relay service;
calculating the expected resource amount for the network relay service from the remote terminal identifier;
calculating a second available resource amount by subtracting the required resource amount from the first available resource amount; and
providing the relay service when the first available resource amount is greater than the expected resource amount for the network relay service.

5. The operation method according to claim 1, wherein the relay terminal identifier includes a relay capacity field and a ratio code field, the relay capacity field indicates the first available resource amount, and the ratio code field indicates a ratio of the required resource amount to the first available resource amount.

6. An operation method of a remote terminal in a communication system, the operation method comprising:
calculating a first expected resource amount for an entire relay service;
calculating a second expected resource amount for a network relay service;
generating a remote terminal identifier reflecting the first expected resource amount and the second expected resource amount;
requesting the network relay service by transmitting the remote terminal identifier to candidate relay terminals; and
using the network relay service by selecting a relay terminal from among candidate relay terminals responding to the request for the network relay service.

7. The operation method according to claim 6, wherein the using of the network relay service comprising:
receiving, from each of the candidate relay terminals, a response to the request for the network relay service including a relay terminal identifier reflecting a first available resource amount and a required resource amount of each of the candidate relay terminals;
calculating a result value obtained by subtracting the required resource amount from the first available resource amount for each of the relay terminal identifiers; and
using the network relay service by selecting a candidate relay terminal having a largest result value among the result values as a relay terminal.

8. The operation method according to claim 6, wherein the remote terminal identifier includes a relay capacity field and a ratio code field, the relay capacity field indicates the first expected resource amount, and the ratio code field indicates a ratio of the second expected resource amount to the first expected resource amount.

9. The operation method according to claim 6, further comprising:
determining whether an update condition for the remote terminal identifier occurs; and
when the update condition occurs, updating the remote terminal identifier according to the update condition.

10. The operation method according to claim 9, wherein the update condition is at least one of a case in which a change in the first expected resource amount is equal to or greater than a first threshold and a case in which a change in the second expected resource amount is equal to or greater than a second threshold.

11. The operation method according to claim 7, further comprising:
determining whether a reason for termination of use of the network relay service occurs;
when the reason for termination of use of the network relay service occurs, requesting termination of the network relay service from the relay terminal; and
terminating use of the network relay service.

12. A relay terminal comprising:
a processor;
a memory electronically communicating with the processor; and
instructions stored in the memory,
wherein when executed by the processor, the instructions cause the relay terminal to:
calculate a first available resource amount of a communication service through a base station;
calculate a required resource amount for the relay terminal;
generate a relay terminal identifier reflecting the first available resource amount and the required resource amount, and provide the relay terminal identifier to a remote terminal; and
provide a relay service to the remote terminal when a request for the relay service is received from the remote terminal.

13. The relay terminal according to claim 12, wherein in the providing of the relay service to the remote terminal, the instructions cause the relay terminal to:
receive, from the remote terminal, the request for the relay service including a remote terminal identifier reflecting an expected resource amount for a network relay service;
calculate the expected resource amount for the network relay service from the remote terminal identifier;
calculate a second available resource amount by subtracting the required resource amount from the first available resource amount; and
provide the relay service when the first available resource amount is greater than the expected resource amount for the network relay service.

14. The relay terminal according to claim 12, wherein the relay terminal identifier includes a relay capacity field and a ratio code field, the relay capacity field indicates the first available resource amount, and the ratio code field indicates a ratio of the required resource amount to the first available resource amount.
